(19) United States
(12) Patent Application Publication
(10) Pub. No.: US 2007/0246140 A1
(43) Pub. Date: Oct. 25, 2007

(54) Device for installing traction chains on dual wheel assemblies

(76) Inventor: Glen Hall, Kelowna (CA)

Correspondence Address: NORMAN M. CAMERON, SUITE 1401 - 1166 ALBERNI STREET, VANCOUVER, BC, V6E 3Z3, CA

(21) Appl. No.: 11/406,529

(22) Filed: Apr. 19, 2006

(51) Int. Cl. B60C 11/00

(52) U.S. Cl. 152/220

(57) ABSTRACT

There is provided a device for installing traction chains about a dual wheel assembly. The device comprises an elongate member having a first end and a second end. A portion of the elongate member adjacent the first end has opposed planar surfaces and the elongate member is of sufficient length to extend from an outer side of the dual wheel assembly to an inner side of the dual wheel assembly. A first hook extends from the first end of the elongate member, the first hook has planar lateral side; a second hook extends from the second end of the elongate member; and a third hook extends from the elongate member, the third hook being disposed between the first hook and the second hook. The elongate member, the first hook, the second hook and the third hook comprising a rigid body.

### BACKGROUND OF THE INVENTION

The present invention relates to a device for installing traction chains about wheels and in particular to a device for installing traction chains about dual wheel assemblies similar to those found on commercial vehicles such as trucks and buses.

Traction chains are conventionally installed about a dual wheel assembly of a commercial vehicle by laying the traction chains on the ground in front or behind the wheel assembly so that the vehicle may be driven forward or backward to position the wheel assembly on top of the chains. The chains may then be secured to the wheel assembly by pulling and lifting the ends of the chains over the wheel assembly and fastening the ends together about the wheel assembly. It will be understood that installation of traction chains on wheel assemblies using this conventional method requires that the vehicle be driven with sufficient accuracy to properly position the wheel assembly on the chains. This can be extremely frustrating and time consuming if multiple attempts are required to properly position the wheel assembly on the chains. Furthermore, pulling and lifting the ends of the chains over the wheel assembly may be physically strenuous and ergonomically awkward for the person installing the chains.

In order to overcome the above mentioned problems associated with the conventional method of installing traction chains, several devices have been developed to assist with the installation of traction chains about wheel assemblies. U.S. Pat. No. 3,547,177 to Valley and U.S. Pat. No. 5,020,396 to Dunn both disclose such a device and are both incorporated herein by reference. The devices disclosed by Valley and Dunn generally comprise a rigid tubular member having a flexible member therein. The tubular member is inserted through openings in the wheel assembly and the flexible member allows for temporary attachment of the traction chains to the device. The wheel assembly is then rotated by driving the vehicle, causing the chain to wind about the wheel assembly. The ends of the chains may then be fastened together about the wheel assembly.

Although the devices disclosed by Valley and Dunn allow for traction chains to be installed about wheel assemblies, the flexible members and complex construction of these devices make them vulnerable to breakage. There are also significant manufacturing costs associated with the prior art multi-component devices. There is therefore a need for a robust device of simple construction to assist with the installation of traction chains about wheel assemblies.

### SUMMARY OF THE INVENTION

According to one aspect of the present invention, there is provided a device for installing traction chains about a dual wheel assembly. The dual wheel assembly including a pair of laterally spaced apart hubs rotatably mounted on an axle. Each hub supporting a tire about a rim portion thereof and each hub having at least one aperture extending laterally therethrough and disposed inwardly from the rim. The respective apertures of the hubs being laterally aligned.

The device comprises an elongate member having a first end and a second end. A portion of the elongate member adjacent the first end has opposed planar surfaces and the elongate member is of sufficient length to extend from an outer side of the dual wheel assembly to an inner side of the dual wheel assembly. A first hook extends from the first end of the elongate member, the first hook has planar lateral side; a second hook extends from the second end of the elongate member; and a third hook extends from the elongate member, the third hook being disposed between the first hook and the second hook. The elongate member, the first hook, the second hook and the third hook comprising a rigid body.

In a preferred embodiment of the invention the elongate member, the first hook and the second hook are integral and formed from a single metal rod. The distance between a point of the first hook and a point of the second hook is 26½ inches. The third hooked is also formed from a metal rod and is welded to the elongate member at a desired location. Preferably the distance between the point of the first hook and the shaft of the third hook is 13¼ inches and the distance between the point of the second hook and the shaft of the third hook is 13¼ inches.

It is an object of the present invention to provide for a robust device of simple construction to assist with the installation of traction chains about wheel assemblies. It is a further object of the present invention to provide a device to assist with the installation of traction chains about wheel assemblies which may be used with wheel assemblies of varying diameters.

### BRIEF DESCRIPTION OF THE DRAWINGS

Referring to the drawings:

FIG. 1 is a front elevational view of device for installing traction chains about dual wheel assemblies according to an embodiment of the invention;

FIG. 2 is another front elevational view of the device of FIG. 1 with dimensions added;

FIG. 3 is a top view of the device of FIG. 1, a traction chain connected thereto and wheels and axles of a vehicle, the wheels being shown in section and the axle in fragment;

FIG. 4 is a side perspective view of a dual wheel assembly, a traction chain and the device of FIG. 1;

FIG. 5 is a cross-section of the device of FIG. 1 through line 5-5;

FIG. 6 is an enlarged front elevational view of the second hook of FIG. 1; and

FIG. 7 is an enlarged front elevational view of the third hook of FIG. 1.

### DETAILED DESCRIPTION OF THE PREFERRED EMBODIMENTS

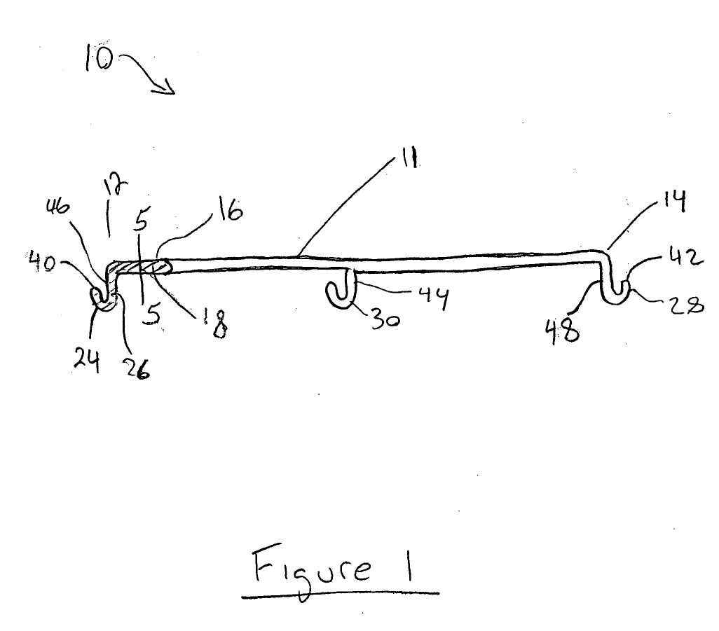

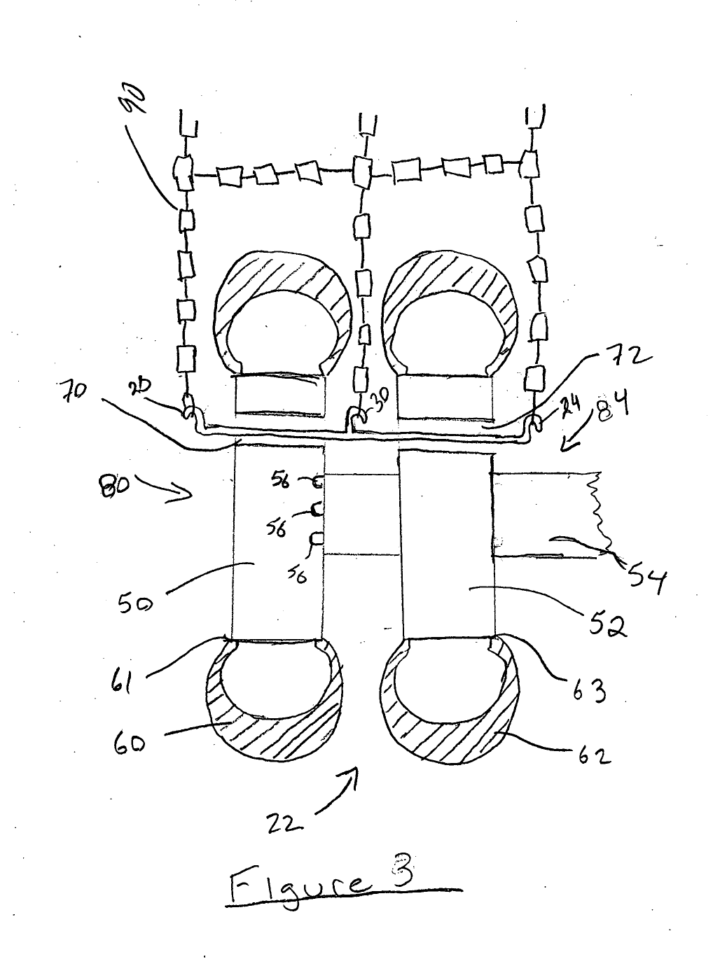

Referring to the drawings and first to FIG. 1, a device 10 for installing traction chains about a dual wheel assembly is shown according to an embodiment of the present invention. There is an elongate member 11 which has a first end 12 and a second end 14. The elongate member is of sufficient length to extend from an outer side 80 of a dual wheel assembly 22 to an inner side 84 the dual wheel assembly as best shown in FIG. 3.

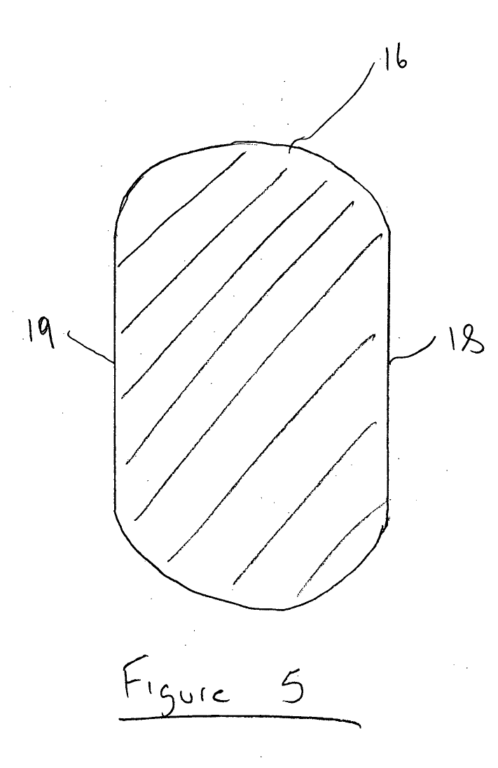

In this example, the elongate member 11 is a steel bar generally circular is cross-section except as described below. A portion 16 of the elongate member 11 adjacent the first end 12 has a planar lateral surfaces 18 and 19 as best shown in shown in FIG. 5 which shows a cross-section of FIG. 1 through line 5-5. However, it will be understood that the elongate member 11 may be made out of other materials and may be other shapes in alternate embodiments of the invention.

Referring back to FIG. 1, a shank 46 of a first hook 24 extends generally outwardly from the first end of the elongate member 11. The first hook 24 has a first planar lateral side 26. A second planar lateral side (not shown) is opposite the first planar lateral side 26 and is similar in shape to the first planar side 26. Preferably the lateral planar sides of the first hook 24 extend 2 inches inwardly from the first end 12 of the first hook. The planar lateral sides of the first hook 24 are generally flush with the planar lateral surfaces of the elongate member 11. A shank 48 of a second hook 28 extends generally outwardly from the second 14 of the elongate member 11. The first hook 24 and the second hook 28 are generally co-planar in this example and their respective points 40 and 42 extend outwardly from the elongate member 11. A shank 44 of a third hook 30 extends generally outwardly from the elongate member 11 along the elongate member. The shank of the third hook is between 1 inch and 3 inches and preferably 1⅝ inch. The third hook 30 is disposed between the first hook 24 and the second hook 28 and the third hook 30 is generally co-planar with the first hook 24 and the second hook 28 in this example. However, it will be understood that in alternate embodiments of the invention that the third hook may aligned along a plane generally perpendicular to the first hook 24 and the second hook 28 or at some other angle. Each of the hooks in this example is a J-shaped hook.

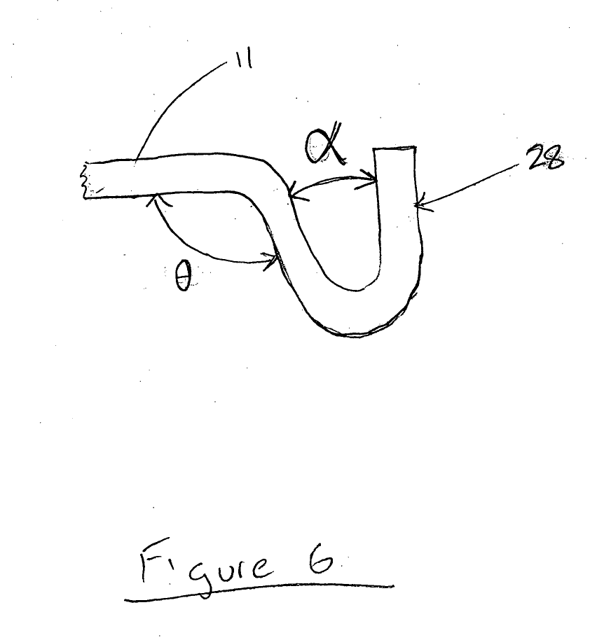

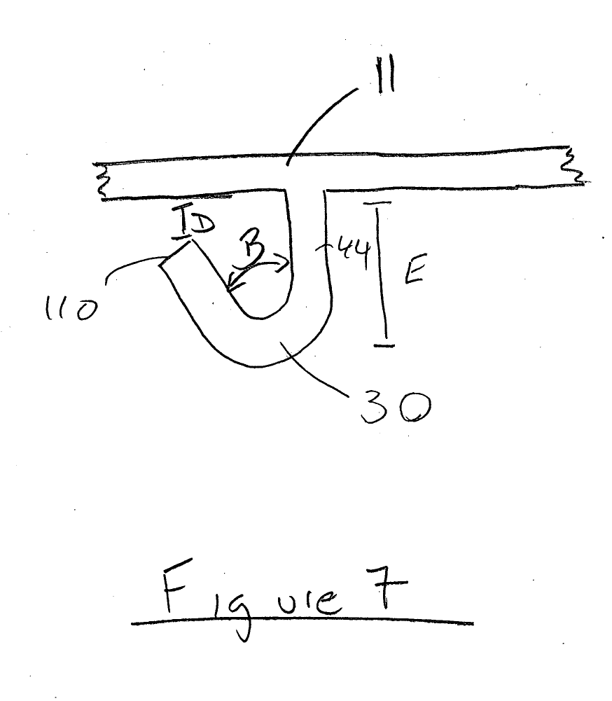

The first hook 24 and the second hook 28 extend outwardly from the elongate member 11 as best shown in FIG. 6 for the second hook 28. Angle θ between the elongate member 11 and the second hook is between 90° and 120° and is preferably 105°. It will be understood that corresponding angle θ between the elongate member 11 and the first hook 24 will also be between 90° and 120° and is preferably 105°. Inner angle α of the second hook 28, shown in FIG. 6, is between 5° and 25° and is preferably 15°. It will be understood that corresponding inner inner angle α of the first hook 24 is between 5° and 25° and is preferably 15°. As shown in FIG. 7 the inner angle β of the third hook 30 is between 15° and 45° and is preferably 30°. The distance D between the point 110 of the third hook 30 and the elongate member 11 is between ¼ of an inch and 2 inches and preferably ½ an inch. The length E of the shank 44 of the third hook 30 is between 1 inch and 3 inches and is preferably 1⅝ inches.

The present invention allows for the elongate member 11, the first hook 24 and the second hook 28 to be integral and to be unitarily formed. For example, the elongate member 11, the first hook 24 and the second hook 28 may be forged from a single rod or tube. Alternately, the elongate member 11, the first hook 24 and the second hook 28 may be cast in a single mold. The third hook 30 may be attached integrally to the elongate member 11 by known means such welding or the third hook 30 may be connected mechanically to the elongate member 11 by a nut and bolt system or the like. Unitary construction of the elongate member 11, the first hook 24 and the second hook 28 provides a robust structure which ables the device 11 to better withstand the stresses associated with installing traction chains as compared to the prior art devices.

In a preferred method of manufacturing the device 10, the elongate member 11, the first hook 24 and the second hook 28 are made of steel and are cast from a single mold. The third hook 30 is also made of steel and it is welded to the elongate member 11 at the desired location. The device 10, may be zinc plated to protect against corrosion due to environmental exposure. Alternately, the device 10 may be coated with anti-corrosion paint.

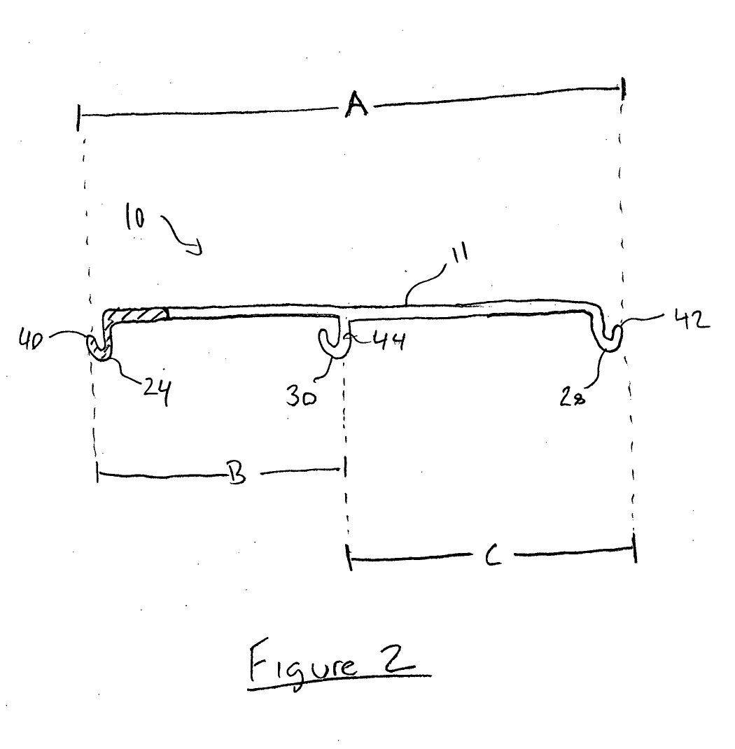

FIG. 2 shows the dimensions of a preferred embodiment of the invention. Typically diameters of dual wheel assemblies found on commercial vehicles range between 22½ inches to 24 inches. In view of this, a preferred distance A between the point 40 of the first hook 24 and the point 42 of the second hook 28 is between 25 inches and 30 inches. A preferred distance B between the point 40 of the first hook 24 and the shank 44 of the third hook 30 is between 11 inches and 19 inches. A preferred distance C between the point 42 of the second hook 28 and the shank 44 of the third hook 30 is between 12 inches and 18 inches.

In a more preferred embodiment of the invention, the distance A between the point 40 of the first hook 24 and the point 42 of the second hook 28 is 26½ inches. The distance B between the point 40 of the first hook 24 and the shank 44 of the third hook 30 is 13¼ inches. The distance C between the point 42 of the second hook 28 and the shank 44 of the third hook 30 is 13¼ inches. The inventors have found that constructing the device using the above mentioned dimensions provides the best means for installing traction chains on the dual wheel assemblies found on commercial vehicles having a diameter of between 22½ inches to 24 inches. However, it will be understood that other dimensions may be used dependent on the diameter of the dual wheel assembly on which the traction chain is being installed.

For example, the inventors have discovered that a device 10 with the following dimensions may also be adequately used to installing traction chains on the dual wheel assemblies found on commercial vehicles having a diameter of between 22½ inches to 24 inches. A distance A between the point 40 of the first hook 24 and the point 42 of the second hook 28 of 27⅝ inches. A distance B between the point 40 of the first hook 24 and the shank 44 of the third hook 30 of 13¼ inches. A distance C between the point 42 of the second hook 28 and the shank 44 of the third hook 30 of 14⅜ inches.

Alternately, the device 10 with the following dimensions may also be adequately used to installing traction chains on the dual wheel assemblies found on commercial vehicles having a diameter of between 22½ inches to 24 inches. A distance A between the point 40 of the first hook 24 and the point 42 of the second hook 28 is 29⅝ inches. A distance B between the point 40 of the first hook 24 and the shank 44 of the third hook 30 is 15¼ inches. A distance C between the point 42 of the second hook 28 and the shank 44 of the third hook 30 of 14⅜ inches.

In operation the device 10 is used to install traction chains on dual wheel assemblies such as dual wheel assembly 22 shown in FIG. 3. Dual wheel assembly 22 includes a pair of laterally spaced apart hubs 50 and 52 mounted on an axle 54 by bolts 56. The hubs support tires 60 and 62 respectively about rim portions 61 and 63 thereof. Hub 50 has an aperture 70 extending laterally therethrough and disposed inwardly from rim portion 61. Hub 52 has an aperture 72 extending laterally therethrough and disposed inwardly from rim portion 63. Apertures 70 and 72 are laterally aligned, allowing the device 10 to be extended through the dual wheel assembly 22, from the outer side 80 of a dual wheel assembly 22 to the inner side 84 the dual wheel assembly 22.

The device 10 is extended through the dual wheel assembly 22 with the first hook 24 leading in the direction indicated by arrow 71. The planar lateral sides of the first hook 24 and the planar surfaces of the elongate member 11 enable the device to easily fit through the innermost hub 52. As shown in FIG. 3, when the device 10 is extended through the dual wheel assembly 22, the first hook 24 is disposed on the inner side 84 of the dual wheel assembly 22, the second hook 28 is disposed on the outer side 80 of the dual wheel assembly 22 and the third hook 30 is disposed between the hubs 50 and 52. A traction chain 90 can then be readily engaged by the device 10 at the hooks 24, 28 and 30.

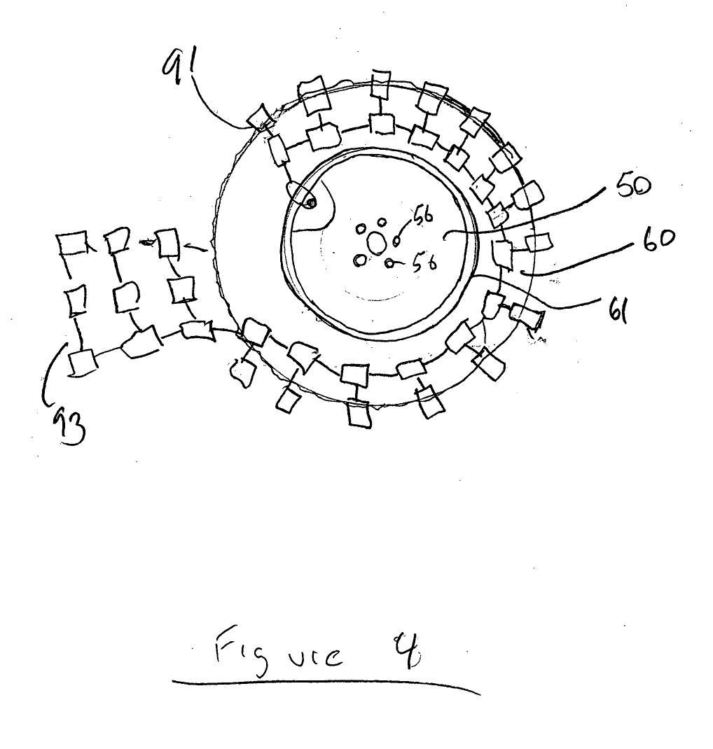

Once the traction chain 90 is engaged by the device 10, the dual wheel assembly 22 is rotated by driving the vehicle (not shown), causing the traction chain 90 to wind about the dual wheel assembly 22, as best shown in FIG. 4. The ends 91 and 93 of the traction chain 90 may then be fastened together by conventional means securing the traction chain 90 about the wheel assembly 22.

The present invention therefore provides a robust device of simple construction used to assist with the installation of traction chains about wheel assemblies.

It will be understood by someone skilled in the art that many of the details provided above are by way of example only and are not intended to limit the scope of the invention which is to be determined with reference to the following claims.

What is claimed is:

1. A device for installing traction chains about a dual wheel assembly of a vehicle, the dual wheel assembly including a pair of laterally spaced-apart hubs rotatably mounted on an axle, each said hub supporting a tire about a rim portion thereof and each said hub having at least one aperture extending laterally therethrough and disposed inwardly from the rim, wherein the respective apertures of said hubs are laterally aligned, the device comprising:
an elongate member having a first end and a second end, a portion of the elongate member adjacent the first end having opposed planar surfaces sides and the elongate member being of sufficient length to extend from an outer side of the dual wheel assembly to an inner side of the dual wheel assembly;
a first hook extending from the first end of the elongate member, the first hook having planar lateral sides;
a second hook extending from the second end of the elongate member; and
a third hook extending from the elongate member, the third hook being disposed between the first hook and the second hook;
wherein the elongate member, the first hook, the second hook and the third hook comprise a rigid body.

2. The device as claimed in claim 1, wherein the elongate member, the first hook and the second hook are unitary.

3. The device as claimed in claim 2, wherein the third hook is integral to the elongate member.

4. The device as claimed in claim 3, wherein the device is coated with an anti-corrosion paint.

5. The device as claimed in claim 3, wherein the device is zinc plated.

6. The device as claimed in claim 1, wherein the first hook is a J-shaped hook, the second hook is a J-shaped hook and the third hooks is a J-shaped hook.

7. The device as claimed in claim 1, wherein the first hook and the second hook are co-planar.

8. The device as claimed in claim 1, wherein the first hook and the third hook are co-planar.

9. The device as claimed in claim 1, wherein the second hook and the third hook are co-planar.

10. The device a claimed in claim 1, wherein the distance between a point of the first hook and a point of the second hook is between 25 inches and 30 inches.

11. The device a claimed in claim 10, wherein the distance between a point of the first hook and a point of the second is 26½ inches.

12. The device as claimed in claim 1, wherein the distance from the point of the first hook to a shank of the third hook is between 11 inches and 19 inches.

13. The device as claimed in claim 12, wherein the distance from the point of the first hook to a shank of the third hook is 13¼ inches.

14. The device as claimed in claim 1, wherein the distance from the point of the second hook to a shank of the third hook is between 12 inches and 18 inches.

15. The device as claimed in claim 13, wherein the distance from the point of the second hook to a shank of the third hook is 13¼ inches.
